(19) United States
(12) Patent Application Publication
(10) Pub. No.: US 2017/0244301 A1
(43) Pub. Date: Aug. 24, 2017

(54) MOTOR ASSEMBLY

(71) Applicants: TOYOTA JIDOSHA KABUSHIKI KAISHA, Toyota-shi (JP); ALCHEMICA CORPORATION, Susono-shi (JP)

(72) Inventors: Hiroshi ISONO, Susono-shi (JP); Nobuyoshi SUGITANI, Susono-shi (JP); Aizoh KUBO, Kyoto-shi (JP)

(73) Assignees: TOYOTA JIDOSHA KABUSHIKI KAISHA, Toyota-shi (JP); ALCHEMICA CORPORATION, Susono-shi (JP)

(21) Appl. No.: 15/430,681

(22) Filed: Feb. 13, 2017

(30) Foreign Application Priority Data
Feb. 18, 2016 (JP) 2016-029045

(51) Int. Cl. H02K 7/102; H02K 5/20; F16D 55/30; F16D 65/853; F16D 65/18

(52) U.S. Cl. CPC H02K 7/102; F16D 65/853; F16D 65/186; F16D 55/30; H02K 5/20; F16D 2065/787

(57) ABSTRACT

A motor assembly having a brake device and a downsized cooling system is provided. The motor assembly comprises a drive motor, a brake device that stops rotation of a motor shaft, and a casing that holds the drive motor and the brake device. The motor assembly further comprises a hollow passage formed in the motor shaft to allow cooling medium to flow therethrough, a centrifugal passage formed in the brake rotor from the hollow passage to an opening of the brake rotor, and a return passage that returns the cooling medium discharged from the opening to the hollow passage.

### CROSS REFERENCE TO RELATED APPLICATION

The present invention claims the benefit of Japanese Patent Application No. 2016-029045 filed on Feb. 18, 2016 with the Japanese Patent Office, the disclosures of which are incorporated herein by reference in its entirety.

### BACKGROUND

Field of the Invention

Embodiments of the present application relate to the art of a motor used as a prime mover of automobiles, and especially to a motor having a brake for halting a motor shaft or an output shaft.

Discussion of the Related Art

JP-A-2012-76506 describes a motor mounting structure of electric vehicle. According to the teachings of JP-A-2012-76506, motors for rotating driving wheels are arranged in such a manner that output shafts extend in a longitudinal direction. The motor mounting structure includes a power transmission device for transmitting power of motors to driving wheels, and a braking device for the driving wheels arranged outside the driving wheels.

JP-A-2008-236996 describes a motor provided with an electromagnetic brake. According to the teaching of JP-A-2008-236996, a brake rotor of the electromagnetic brake is fixed to one end of a motor shaft (i.e., an output shaft of the motor). Specifically, the electromagnetic brake taught by JP-A-2008-236996 comprises: the brake rotor fixed to the motor shaft; an armature that is contacted with and separated from the friction plate of the brake rotor; a spring for pushing the armature toward the friction plate; and a brake stator including an electromagnet that attracts the armature by an attracting force larger than the pushing force of the spring. The brake rotor is brought into frictional engagement with the brake stator by energizing the electromagnet to halt the motor shaft.

Specifically, JP-A-2012-76506 describes an inboard brake in which the brake device of the driving wheel is disposed close to a body of an electric vehicle. By using the inboard brake taught by JP-A-2012-76506 instead of the conventional brake device, an unsprung load of the vehicle may be reduced, and additional design freedom may be obtained.

The electric vehicle may be downsized by integrating the motor and the brake device. For example, the electric vehicle may be downsized and lightened by using the motor assembly taught by JP-A-2008-236996. In addition, the electromagnetic brake taught by JP-A-2008-236996 may serve as an inboard brake in a vehicle. However, a cooling system is required to cool the above-explained conventional brake used as the inboard brake in a vehicle, and those conventional inboard brakes have be downsized for use as the inboard brake in vehicles.

### SUMMARY

Aspects of embodiments of the present application have been conceived noting the foregoing technical problems, and it is therefore an object of embodiments of the present invention is to provide a motor assembly having a brake device and a downsized cooling system that may serve as a prime mover in automobiles.

The present application relates to a motor assembly comprising: a drive motor that outputs torque from a motor shaft; a brake stator that is restricted to rotate around the motor shaft; a brake rotor that is rotated integrally with the motor shaft and relatively to the brake stator; a brake device that frictionally engages the brake stator with the brake rotor to stop rotation of the motor shaft; and a casing that holds the drive motor and the brake device. In order to achieve the above-explained objective, according to the embodiment of the present application, the motor assembly is provided with: a cooling medium held in the casing to cool and lubricate the drive motor and the brake device; a hollow passage formed in the motor shaft to allow the cooling medium to flow therethrough; a centrifugal passage that is formed in the brake rotor in such a manner as to penetrate through the brake rotor from the hollow passage to an opening formed at an outer circumference of the brake rotor to discharge the cooling medium from the opening by centrifugal action resulting from rotation of the brake rotor; and a return passage that returns the cooling medium discharged from the opening of the brake rotor to the hollow passage.

In a non-limiting embodiment, the motor assembly may further comprises a reservoir tank that is disposed outside of the casing to hold the cooling medium. In addition, the return passage may include a first passage connecting the opening of the brake rotor to an inlet of the reservoir tank while penetrating through the casing to deliver the cooling medium from the opening to the reservoir tank, and a second passage connecting an outlet of the reservoir tank to an internal space of the casing while penetrating through the casing to deliver the cooling medium from the reservoir to the casing.

In a non-limiting embodiment, the brake rotor may include a friction face formed on an outer circumferential portion that is frictionally engaged with the brake stator to stop the rotation of the motor shaft.

In a non-limiting embodiment, the brake device may include an electromagnetic brake adapted to generate a magnetic force when energized to engage the brake stator with the brake rotor.

Thus, according to the embodiment of the present application, the drive motor is provided with the electromagnetic brake for stopping the rotation of the motor shaft. That is, the motor assembly according to the embodiment may be used not only as a prime mover of an automobile but also as an inboard brake. According to the embodiment of the present application, therefore, an unsprung load of a vehicle may be reduced. As described, in the motor assembly, both of the drive motor and the brake device are held in the casing, and the cooling medium is also held in the casing. For this reason, the drive motor and the brake device may be cooled by the cooling medium. As also described, the hollow passage is formed in the motor shaft, and the hollow passage is connected to the centrifugal passage formed in the brake rotor. In addition, the return passage is formed outside of the casing to return the cooling medium to the hollow passage. In the motor assembly, therefore, the motor shaft 9 and the brake rotor 12 serve as a centrifugal pump to centrifugally discharge the cooling medium from the hollow passage. The cooling medium is then returned to the casing through the return passage. According to the embodiment of the present application, therefore, the cooling medium may be circulated in the hollow passage and the return passage while cooling the drive motor and the brake device. In addition, since the drive motor and the brake device are cooled by the cooling system thus having a simple structure, the motor assembly may be downsized and lightened.

As described, in the motor assembly according to the embodiment of the present application, the return passage on which the reservoir tank is disposed is formed outside of the casing. That is, the cooling medium heated as a result of cooling the drive motor and the brake device in the casing is cooled outside of the casing and then returned to the casing. According to the embodiment of the present application, therefore, the drive motor and the brake device are cooled effectively.

As also described, the cooling medium is discharged from the outer circumferential portion of the brake rotor being opposed to the brake stator. According to the embodiment of the present application, therefore, the brake stator may also be cooled by the cooling medium.

In addition, since the electromagnetic brake is used as the brake device, a hydraulic system and reinforcements such as a brake caliper and so on may be omitted, and hence the motor drive unit may be downsized and lightened.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a cross-sectional view showing a preferred example of the motor assembly according to the present application; and

FIG. 2 is a cross-sectional view showing another example of the motor assembly according to the present application.

### DETAILED DESCRIPTION OF THE PREFERRED EMBODIMENT(S)

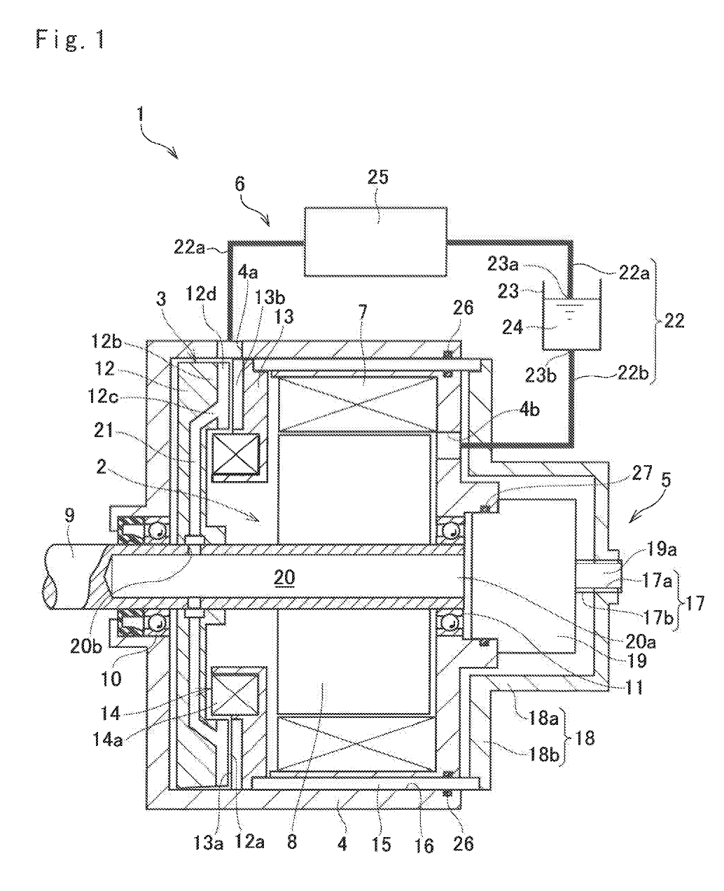

Preferred embodiments of the present application will now be explained with reference to the accompanying drawings. Referring now to FIG. 1, there is shown a preferred example of the motor assembly according to the present application. As illustrated in FIG. 1, a motor assembly 1 comprises a drive motor 2, a brake device 3, a casing 4 holding the drive motor 2 and the brake device 3 therein, a parking brake device 5 and a cooling device 6.

The drive motor 2 is intended to be used as a prime mover of a vehicle, and for example, a permanent magnet synchronous motor, and an induction motor may be used as the drive motor 2. Specifically, the drive motor 2 comprises a stator 7 that is fixed to an inner face of the casing 4, a motor shaft 9 as an output shaft of the drive motor 2 that is supported by bearings 10 and 11 in a rotatable manner at both ends of the casing 4, and a rotor 8 fitted onto the motor shaft 9 to be rotated integrally with the motor shaft 9 but relatively to the stator 7. One of end portions of the motor shaft 9 (of the left side in FIG. 1) protrudes from the casing 4, and the other end portion of the motor shaft 9 (of the right side in FIG. 1) is held in the casing 4.

The brake device 3 is adapted to stop rotation of the motor shaft 9. Specifically, the brake device 3 comprises a brake rotor 12, a brake stator 13, and a brake solenoid 14. When the brake solenoid 14 is energized, the brake stator 13 is brought into contact to the brake rotor 12 to generate braking torque for stopping the rotation of the motor shaft 9. That is, the electromagnetic brake 3 will not generate braking torque unless the brake solenoid 14 is energized.

The brake rotor 12 is a disc-shaped magnetic member, and the brake rotor 12 is also fitted onto the motor shaft 9 to be rotated integrally with the motor shaft 9. A first friction face 12a is formed on an outer circumferential portion of one face the brake rotor 12 to be opposed to a below-mentioned second friction face 13a of the brake stator 13.

The brake stator 13 is an annular magnetic member, and the brake stator 13 is supported by at least two push rods 15 individually as a rod member or a pipe member at an outer circumferential portion of a face opposite to the second friction face 13a. Specifically, each of the push rods 15 is individually inserted into through holes 16 penetrating through the casing 4 in an axial direction, and one end of each of the push rods 15 is individually fitted into insertion holes or notches formed on the outer circumferential portion of the opposite face of the brake stator 13 to the second friction face 13a.

Thus, in the casing 4, the brake stator 13 is supported by the rod members 15 while being allowed to reciprocate in the axial direction but restricted to rotate around the motor shaft 9. That is, the push rods 15 serve as a torque receiving mechanism for restricting the rotation of the brake stator 13.

The push rods 15 may be fitted loosely into the insertion holes of the brake stator 13. Alternatively, the push rods 15 may also be fitted tightly into the insertion holes of the brake stator 13, or fixed to each other by a bolt, an adhesive agent or a welding. In this case, the push rods 15 are reciprocated in the through holes 16 integrally with the brake stator 13. That is, the rods 15 may also serve as a guide mechanism to reciprocate the brake stator 13 in the axial direction.

The above-mentioned second friction face 13a is formed on the outer circumferential portion of the face of the brake stator 13 opposed to the first friction face 12a of the brake rotor 12.

The brake solenoid 14 comprises the brake rotor 12 serving as a fixed magnetic pole, a coil 14a wound around an iron core (not shown), and the brake stator 13 serving as a movable magnetic pole. The coil 14a is attached to the brake stator 13 so that the coil 14a is reciprocated together with the brake stator 13. Specifically, when a predetermined current is applied to the coil 14a, the coil 14a establishes magnetic attraction to be pulled toward the brake rotor 12 together with the brake stator 13. Consequently, the second friction face 13a of the brake stator 13 is frictionally engaged with the first friction face 12a of the brake rotor 12 to stop the rotation of the motor shaft 9. Optionally, although not especially illustrated in FIG. 1, a return spring may be used to isolate the second friction face 13a away from the first friction face 12a when stopping current supply to the coil 14a to allow the motor shaft 9 to rotate.

The parking brake device 5 is adapted to generate thrust force for pushing the brake stator 13 toward the brake rotor 12 to keep the frictional engagement between the brake stator 13 and the brake rotor 12 to stop the rotation of the motor shaft 9 even when stopping current supply to the brake solenoid 14 is stopped. According to the first example shown in FIG. 1, specifically, the parking brake device 5 comprises a feed screw mechanism 17, a pushing member 18, and a brake motor 19.

The pushing member 18 includes a cover member 18a covering the brake motor 19 and a flange member 18b expanding radially outwardly from an opening of the cover member 18a. A female thread hole 17a is formed on a center of a bottom of the cover member 18a.

The brake motor 6 is held in the cover member 18a while being fixed to the casing 4. The other end of each of the push rods 15 is individually fitted into insertion holes or notches formed on an outer circumferential portion of the flange member 18b.

A male thread 17b is formed on an outer circumferential surface of an output shaft 19a of the brake motor 19, and the male thread 17b is screwed into the female thread hole 17a of the cover member 18a.

For example, a ball screw actuator, a trapezoidal screw actuator, a square screw actuator etc. may serve as the female thread hole 17a and the male thread 17b. Specifically, the feed screw mechanism 17 generates a thrust force (or an axial force) for pushing the pushing member 18 in the axial direction toward the drive motor 2 by rotating the output shaft 19a of the brake motor 19 on which the male thread 17b is formed in a predetermined direction (i.e., in the forward direction). By contrast, the pushing member 18 is withdrawn from the drive motor 2 by rotating the output shaft 19a of the brake motor 19 in the opposite direction (i.e., in the reverse direction).

Thus, in the parking brake device 5, the feed screw mechanism 17 generates forward thrust force by generating forward torque by the brake motor 19, and the forward thrust force is applied to the brake stator 13 through the pushing member 18 and the push rods 15. Consequently, the brake stator 13 is pushed toward the brake rotor 12 so that the second friction face 13a of the brake stator 13 is frictionally engaged with the first friction face 12a of the brake rotor 12 to stop the rotation of the motor shaft 9. By contrast, the motor shaft 9 is allowed to rotate by generating a reverse torque by the brake motor 19 to withdraw the second friction face 13a of the brake stator 13 from the first friction face 12a of the brake rotor 12. That is, the braking force for stopping the rotation of the motor shaft 9 is cancelled.

In addition, reversed efficiency of the feed screw mechanism 17 to translate linear motion to rotational motion is adjusted to be lower than forward efficiency to translate rotational motion to linear motion. That is, mechanical efficiency of the feed screw mechanism 17 is tuned in such a manner that the pushing member 18 is moved more efficiently toward the brake rotor 12 by rotating the male thread 17b in the forward direction, and that the male thread 17b is rotated in the reverse direction less efficiently by withdrawing the pushing member 18 from the brake rotor 12. According to the preferred example, therefore, the motor shaft 9 may be halted easily by pushing the brake stator 13 toward the brake rotor 12 by the feed screw mechanism 17 even when the coil 14a of the brake solenoid 14 and the brake motor 19 are unenergized.

As described, the motor assembly 1 is used as a prime mover of automobiles, and a temperature thereof is when rotated at a high speed or when subjected to a large load. In addition, the brake device 3 is frictionally heated as a result of generating the braking force. In order to cool the drive motor 2 and the brake device 3, the motor assembly 1 is provided with a cooling system 6.

The cooling system 6 comprises a hollow passage 20 formed in the motor shaft 9, a centrifugal passage 21, a return passage 22, a reservoir tank 23 and a cooling medium. For example, water, oil, air, inert gas and so on may be used as the cooling medium. According to the preferred embodiment, oil 24 is employed as the cooling medium not only to cool the drive motor 2 and the brake device 3 but also to lubricate the drive motor 2. Specifically, the oil 24 is held in the casing 4 in an amount possible to flow through the hollow passage 20 during operation of the drive motor 2.

The hollow passage 20 is formed in the motor shaft 9 of the drive motor 2 in the axial direction. Specifically, a leading end (of the left side in FIG. 1) of the hollow passage 20 is closed, and an opening 20a is formed on other end (of the right side in FIG. 1) to allow the oil 24 held in the casing 4 to flow into the hollow passage 20.

In addition, a through hole 20b is formed on the motor shaft 9 at a portion on which the brake rotor 12 is fitted to provide a connection between the hollow passage 20 and the centrifugal passage 21. In the embodiment shown in FIG. 1, the same number of the through hole 20b as the centrifugal passage 21 is formed on the motor shaft 9 in the circumferential direction.

A plurality of the centrifugal passages 21 are formed in the brake rotor 12 in such a manner as to penetrate through the brake rotor 12 radially from the through holes 20b toward openings 12c at regular intervals.

On the first friction face 12a of the brake rotor 12, a plurality of grooves 12d are formed radially from the openings 12c to an outer circumferential edge 12b of the brake rotor 12. Thus, the centrifugal passages 21 are formed in the brake rotor 12 radially from the through holes 20b to outer circumferential edge 12b of the brake rotor 12.

As described, the oil 24 is held in the casing 4 so that the hollow passage 20 is filled with the oil 24. During operation of the drive motor 2, the rotor 8, the motor shaft 9 and the brake rotor 12 are rotated so that the oil 24 in the hollow passage 20 is attracted to an inner circumferential face of the motor shaft 9 by the centrifugal action. Consequently, the oil 24 in the hollow passage 20 flows into the centrifugal passages 21 from the through holes 20b. In this situation, since the brake rotor 12 is also rotated together with the motor shaft 9, the oil 24 flowing into the centrifugal passages 21 is further attracted to the openings 12c by the centrifugal action. The oil 24 flowing out of the openings 12c further attracted radially outwardly through the grooves 12d, and eventually scattered from the outer circumference of the brake rotor 12. As a result, an internal pressure of the hollow passage 20 becomes negative and hence the oil 24 flowing outside of the hollow passage 20 is sucked into hollow passage 20. Thus, the motor shaft 9 and the brake rotor 12 serve as a centrifugal pump to centrifugally circulate the oil 24 between the casing 4 and the cooling system 6.

A plurality of grooves 13b are also formed radially on the second friction face 13a of the brake stator 13 while being faced to the grooves 12b formed on the first friction face 12a of the brake rotor 12. In the motor assembly 1, therefore, the brake stator 13 may also be cooled efficiently by the oil 24 flowing through the grooves 13b.

In order to return the oil 24 flowing out of the brake rotor 12 to the hollow passage 20, the return passage 22 is formed outside of the casing 4. The return passage 22 includes a first passage 22a and a second passage 22b, and a reservoir tank 23 is disposed on the return passage 22 to temporarily hold the oil 24 therein.

A through hole 4a is formed on the casing 4 at a portion facing to the outer circumferential edge 12b of the brake rotor 12, and the first passage 22a connects the through hole 4a to an inlet 23a of the reservoir tank 23. In the motor assembly 1, therefore, the oil 24 scattered from the brake rotor 12 is allowed to partially flow into the first passage 22a through the through hole 4a. Optionally, an oil cooler 25 may be arranged on the first passage 22a to cool the oil flowing through the first passage 22a before reaching the reservoir tank 23. Since the oil cooler 25 and the reservoir tank 23 are arranged outside of the casing 4, a temperature of the oil 24 may be lowered certainly thereby cooling the brake rotor 12 and the brake stator 13 effectively.

An outlet 23b of the reservoir tank 23 is connected to another through hole 4b of the casing 4 through the second passage 22b. For example, another through hole 4b is formed on a side wall of the casing 4 of the parking brake device 5 side at a level lower than the reservoir tank 23 in an application direction of the motor assembly 1. In addition, an upper face of the reservoir tank 23 is partially opened to the atmosphere so that the oil 24 held in the reservoir tank 23 is allowed to gravitationally flow down into the casing 4 from another through hole 4b. Optionally, an elastic member such as a spring may be used to discharge the oil 24 from the outlet 23b of the reservoir tank 23. In this case, another through hole 4b may be situated at a level higher than the outlet 23b of the reservoir tank 23.

In order to keep the liquid-tight condition in the casing 4, a clearance between the push rod 15 and the through hole 16 is sealed by an O-ring 26, and a clearance between the casing 4 and the brake motor 19 is sealed by an O-ring 27.

Thus, the hollow passage formed in the motor shaft 9, the centrifugal passages 21 formed in the brake rotor 12 and the return passage 22 formed outside of the casing 4 serve as the cooling system 6. During operation of the drive motor 2, therefore, the oil 24 flowing through the hollow passage 20 is centrifugally delivered to the centrifugal passages 21, and further delivered to the return passage 22. That is, the motor shaft 9 and the brake rotor 12 serve as a centrifugal pump, and the oil 24 flowing through the return passage 22 is returned to the hollow passage 20. In the motor assembly 1, therefore, the drive motor 2 and the brake device 3 may be cooled effectively by the oil 24 thus circulating in the cooling system 6. In addition, since the drive motor 2 and the brake device 3 are cooled by the cooling system 6 thus having a simple structure, the motor assembly 1 may be downsized and lightened.

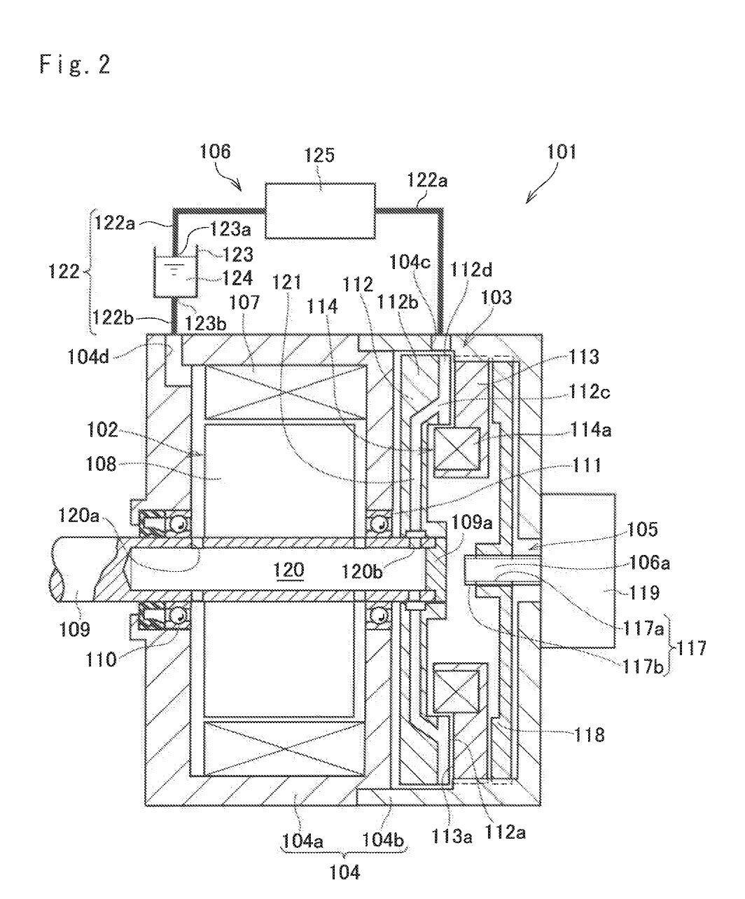

Turning to FIG. 2, there is shown another embodiment according to the present application. As illustrated in FIG. 2, a motor assembly 101 comprises a drive motor 102, a brake device 103, a casing 104 holding the drive motor 102 and the brake device 103 therein, a parking brake device 105 and a cooling system 106. According to the second example, the casing 104 is divided into a motor case 104a and a brake case 104b, and an opening end of the brake case 104b is attached to one of axial ends of the motor case 104a.

As the drive motor 2 of the preferred example, the drive motor 102 comprises a stator 107 that is fixed to an inner face of the motor case 104a, a motor shaft 109 as an output shaft of the drive motor 102 that is supported by bearings 110 and 111 in a rotatable manner at both ends of the motor case 104a, and a rotor 108 fitted onto the rotor shaft 109 to be rotated integrally with the rotor shaft 109 but relatively to the stator 107. In the motor assembly 101, a hollow passage 120 is also formed in the motor shaft 109.

The brake device 103 comprises a brake rotor 112, a brake stator 113, and a brake solenoid 114. When the brake solenoid 114 is energized, the brake stator 113 is brought into contact to the brake rotor 112 to generate braking torque for stopping the rotation of the motor shaft 109. That is, the brake device 103 will not generate braking torque unless the brake solenoid 114 is energized.

The brake rotor 112 is also a disc-shaped magnetic member, and the brake rotor 112 is fitted onto the motor shaft 109 to be rotated integrally therewith in the brake case 104b. A first friction face 112a is formed on an outer circumferential portion of one face the brake rotor 112 to be opposed to a below-mentioned second friction face 113a of the brake stator 13. In the motor assembly 101, a hollow passage 121 is also formed in the brake rotor 112.

The brake stator 113 is also an annular magnetic member, and the brake stator 113 is splined to an inner circumferential face of the brake case 104b. Specifically, a spline ridge is formed on an outer circumferential face of the brake stator 113 in the axial direction, and the spline ridge of the brake stator 113 is fitted into a spline groove formed on the inner circumferential face of the brake case 104b in the axial direction. Thus, in the brake case 104b, the brake stator 113 is allowed to reciprocate in the axial direction but restricted to rotate around the motor shaft 109.

The brake solenoid 114 comprises the brake rotor 112 serving as a fixed magnetic pole, a coil 114a wound around an iron core (not shown), and the brake stator 113 serving as a movable magnetic pole. The coil 114a is attached to the brake stator 113 so that the coil 114a is reciprocated together with the brake stator 113. Specifically, when a predetermined current is applied to the coil 114a, the coil 114a establishes magnetic attraction to be pulled toward the brake rotor 112 together with the brake stator 113.

The parking brake device 105 is adapted to generate thrust force for pushing the brake stator 113 toward the brake rotor 112 to keep the frictional engagement between the brake stator 113 and the brake rotor 112 to stop the rotation of the motor shaft 109 even when stopping current supply to the brake solenoid 114 is stopped. According to another embodiment shown in FIG. 2, specifically, the parking brake device 105 comprises a feed screw mechanism 117, a disc-shaped pushing plate 118 and a brake motor 119.

Specifically, a spline ridge is formed on an outer circumferential face of the pushing plate 118 in the axial direction, and the spline ridge of the pushing plate 118 is fitted into the spline groove formed on the inner circumferential face of the brake case 104b in the axial direction. Thus, in the brake case 104b, the pushing plate 118 is also allowed to reciprocate in the axial direction but restricted to rotate around the motor shaft 109. That is, the pushing plate 118 is moved forward on the motor shaft 109 by the parking brake device 105 to push the brake stator 113.

A female thread hole 117a is formed on a center of the pushing plate 118, and the brake motor 119 is attached to an outer face of the brake case 104b coaxially with the motor shaft 109.

A male thread 117b is formed on an outer circumferential surface of an output shaft 119a of the brake motor 119, and the male thread 117b is screwed into the female thread hole 117a of the pushing plate 118 toward the brake rotor 112.

Specifically, the feed screw mechanism 117 generates a thrust force (or an axial force) for pushing the pushing member 118 in the axial direction toward the drive motor 102 by rotating the output shaft 119a of the brake motor 119 on which the male thread 117b is formed in the forward direction. By contrast, the pushing plate 118 is withdrawn from the drive motor 102 by rotating the output shaft 119a of the brake motor 119 in the reverse direction.

Thus, in the parking brake device 105, the feed screw mechanism 117 generates forward thrust force by generating forward torque by the brake motor 119, and the forward thrust force is applied to the brake stator 113 through the pushing plate 118. Consequently, the brake stator 113 is pushed toward the brake rotor 112 so that the second friction face 113a of the brake stator 113 is frictionally engaged with the first friction face 112a of the brake rotor 112 to stop the rotation of the motor shaft 109. By contrast, the motor shaft 109 is allowed to rotate by generating a reverse torque by the brake motor 119 to withdraw the pushing plate 118 so that the second friction face 113a of the brake stator 113 is disengaged from the first friction face 112a of the brake rotor 112. That is, the braking force for stopping the rotation of the motor shaft 9 is cancelled.

In addition, reversed efficiency of the feed screw mechanism 117 to translate linear motion to rotational motion is also adjusted to be lower than forward efficiency to translate rotational motion to linear motion. According to another embodiment, therefore, the motor shaft 109 may also be halted easily by pushing the brake stator 113 toward the brake rotor 112 by the feed screw mechanism 117 even when the coil 114a of the brake solenoid 114 and the brake motor 119 are unenergized.

In order to cool the drive motor 102 and the brake device 1033, the motor assembly 101 is also provided with a cooling system 106.

The cooling system 106 comprises the hollow passage 120 formed in the motor shaft 109, a centrifugal passage 121, a return passage 122, a reservoir tank 123 and a cooling medium. According to another embodiment, oil 124 is also employed as the cooling medium not only to cool the drive motor 102 and the brake device 103 but also to lubricate the drive motor 102. Specifically, the oil 124 is held in the casing 104 in an amount possible to flow through the hollow passage 120 during operation of the drive motor 2.

The hollow passage 120 is formed in the motor shaft 109 of the drive motor 102 in the axial direction. Specifically, a leading end (of the left side in FIG. 2) of the hollow passage 20 is closed in the motor shaft 109, and a rear end (of the right side in FIG. 2) of the hollow passage 20 is closed by a lid 109a such as a plug bolt. An inlet 120a is formed on the motor shaft 109 at a portion in the vicinity of the leading end thereof. Specifically, in order to allow the oil 124 held in the casing 104 to enter into the hollow passage 20, a pair of inlets 120a are formed on the motor shaft 109 between the rotor 108 and a side wall of the casing 104 situated in the leading end side of the motor shaft 109.

In addition, a through hole 120b is formed on the motor shaft 109 at a portion on which the brake rotor 112 is fitted to provide a connection between the hollow passage 120 and the centrifugal passage 21. In another embodiment shown in FIG. 2, the same number of the through hole 120b as the centrifugal passage 21 is formed on the motor shaft 109 in the circumferential direction.

A plurality of the centrifugal passages 21 are formed in the brake rotor 112 radially from the through holes 120b toward openings 112c at regular intervals.

On the first friction face 112a of the brake rotor 112, a plurality of grooves 112d are formed radially from the openings 112c to an outer circumferential edge 112b of the brake rotor 112. Thus, the centrifugal passages 121 are formed in the brake rotor 112 radially from the through holes 120b to outer circumferential edge 112b of the brake rotor 112.

As described, the oil 124 is held in the casing 104 so that the hollow passage 120 is filled with the oil 124. During operation of the drive motor 102, the rotor 108, the motor shaft 109 and the brake rotor 112 are rotated so that the oil 124 and the air in the hollow passage 120 is attracted to an inner circumferential face of the motor shaft 109 by the centrifugal action. Consequently, the oil 124 in the hollow passage 120 flows into the centrifugal passages 21 from the through holes 120b. As a result, an internal pressure of the hollow passage 120 becomes negative and hence the oil 124 flowing outside of the hollow passage 120 is sucked into hollow passage 120 from the inlets 120a.

In this situation, since the brake rotor 112 is also rotated together with the motor shaft 109, the oil 124 flowing into the centrifugal passages 121 is further attracted to the openings 112c by the centrifugal action. The oil 124 flowing out of the openings 112c further attracted radially outwardly through the grooves 112d, and eventually scattered from the outer circumference of the brake rotor 112.

In order to return the oil 124 flowing out of the brake rotor 112 to the hollow passage 120, the return passage 122 is formed outside of the casing 104. The return passage 122 includes a first passage 122a and a second passage 122b, and a reservoir tank 123 is disposed on the return passage 122 to temporarily hold the oil 124 therein.

A through hole 104c is formed on the casing 104 at a portion facing to the outer circumferential edge 112b of the brake rotor 112, and the first passage 122a connects the through hole 104c to an inlet 123a of the reservoir tank 123. In the motor assembly 101, therefore, the oil 124 scattered from the brake rotor 112 is allowed to partially flow into the first passage 122a through the through hole 104c. Thus, the motor shaft 109 and the brake rotor 112 serve as a centrifugal pump to centrifugally circulate the oil 124 between the casing 104 and the cooling system 106.

Optionally, an oil cooler 125 may also be arranged on the first passage 122a to cool the oil flowing through the first passage 122a before reaching the reservoir tank 123. Since the oil cooler 125 and the reservoir tank 123 are arranged outside of the casing 104, a temperature of the oil 124 may be lowered certainly thereby cooling the brake rotor 112 and the brake stator 113 effectively.

An outlet 123b of the reservoir tank 123 is connected to another through hole 104d of the casing 104 through the second passage 122b. For example, another through hole 104d is formed on a side wall of the casing 104 of the leading end side of the output shaft 109 at a level lower than the reservoir tank 123 in an application direction of the motor assembly 101. In addition, an upper face of the reservoir tank 123 is partially opened to the atmosphere so that the oil 124 held in the reservoir tank 123 is allowed to gravitationally flow down into the casing 104 from another through hole 104d. Optionally, an elastic member such as a spring may also be used to discharge the oil 124 from the outlet 123b of the reservoir tank 23. In this case, another through hole 104d may be situated at a level higher than the outlet 123b of the reservoir tank 123.

Although the above exemplary embodiment of the present application has been described, it will be understood by those skilled in the art that the present application should not be limited to the described exemplary embodiment, and various changes and modifications can be made within the spirit and scope of the present application.

What is claimed is:

1. A motor assembly, comprising:
a drive motor that outputs torque from a motor shaft;
a brake stator that is restricted to rotate around the motor shaft;
a brake rotor that is rotated integrally with the motor shaft and relatively to the brake stator;
a brake device that frictionally engages the brake stator with the brake rotor to stop rotation of the motor shaft;
a casing that holds the drive motor and the brake device;
a cooling medium held in the casing to cool and lubricate the drive motor and the brake device;
a hollow passage formed in the motor shaft to allow the cooling medium to flow therethrough;
a centrifugal passage that is formed in the brake rotor in such a manner as to penetrate through the brake rotor from the hollow passage to an opening formed at an outer circumference of the brake rotor to discharge the cooling medium from the opening by centrifugal action resulting from rotation of the brake rotor; and
a return passage that returns the cooling medium discharged from the opening of the brake rotor to the hollow passage.

2. The motor assembly as claimed in claim 1, further comprising:
a reservoir tank that is disposed outside of the casing to hold the cooling medium,
wherein the return passage includes a first passage connecting the opening of the brake rotor to an inlet of the reservoir tank while penetrating through the casing to deliver the cooling medium from the opening to the reservoir tank, and a second passage connecting an outlet of the reservoir tank to an internal space of the casing while penetrating through the casing to deliver the cooling medium from the reservoir to the casing.

3. The motor assembly as claimed in claim 1, wherein the brake rotor includes a friction face formed on an outer circumferential portion that is frictionally engaged with the brake stator to stop the rotation of the motor shaft.

4. The motor assembly as claimed in claim 1, wherein the brake device includes an electromagnetic brake adapted to generate a magnetic force when energized to engage the brake stator with the brake rotor.

5. The motor assembly as claimed in claim 2, wherein the brake rotor includes a friction face formed on an outer circumferential portion that is frictionally engaged with the brake stator to stop the rotation of the motor shaft.

6. The motor assembly as claimed in claim 2, wherein the brake device includes an electromagnetic brake adapted to generate a magnetic force when energized to engage the brake stator with the brake rotor.

7. The motor assembly as claimed in claim 3, wherein the brake device includes an electromagnetic brake adapted to generate a magnetic force when energized to engage the brake stator with the brake rotor.

8. The motor assembly as claimed in claim 5, wherein the brake device includes an electromagnetic brake adapted to generate a magnetic force when energized to engage the brake stator with the brake rotor.
